(19) United States
(12) Patent Application Publication
(10) Pub. No.: US 2007/0073437 A1
(43) Pub. Date: Mar. 29, 2007

(54) Method to monitor proper fastening of an article of assembly at more than one location

(75) Inventor: Michael A. Walt II, Chicago, IL (US)

Correspondence Address: REINHART BOERNER VAN DEUREN P.C., 2215 PERRYGREEN WAY, ROCKFORD, IL, 61107, US

(73) Assignee: LMS-Walt, Inc., Dekalb, IL (US)

(21) Appl. No.: 11/224,536

(22) Filed: Sep. 12, 2005

(51) Int. Cl. G06F 19/00

(52) U.S. Cl. 700/174; 411/261

(57) ABSTRACT

A full proof method to relate torque values to a fastener position has been presented. A unique number based on a position location is used in conjunction with running fasteners in a fixed order allows a person to be able to prove the torque value of an installed fastener. The method may be used in a single assembly fastener station environment or a multiple assembly fastener station environment.

### FIELD OF THE INVENTION

This invention pertains generally to assembly systems, and more particularly relates to monitoring fastening of articles of assemblies in such assembly systems.

### BACKGROUND OF THE INVENTION

There are many industries where the sequence of fastening operations and/or the applied torque of fastening operations are critical in assembling an article of assembly. One such particular industry is the automotive seat assembly industry.

In the automotive seat assembly industry, if the fastening operation of screws on a seat frame is not performed correctly to fasten the parts of the seat together, then the assembled seat may be more prone to possible failure. Proper fastening of a screw may require a predetermined amount of torque to be applied to one or more screws or that the screws be fastened according to a predetermined sequence, or possibly both requirements. It is also necessary that all of the fastening locations be properly subject to a fastening operation and filled with a fastener.

A common requirement in the seat industry is that certain critical screws need to be fastened with a predetermined amount of torque. The amount of torque required for different screws among a seat can also sometimes be different. Screw torque requirements can be so critical for certain industries that monetary fines or disqualification of manufactured product can occur if certain critical screws that have not been properly fastened or torqued to the predetermined value.

In seat assembly operations, it is desirable to assemble a large volume of seats on an assembly line. In modem systems, this is typically accomplished with conveyor systems that carry seats held in fixtures through multiple assembly stations. Conveyor systems may be a continuously moving line whereby seats are worked-on and assembled as the seats are moving and traveling down the line, or as an intermittent stop and go system whereby seats are temporarily stopped at each station for assembly operations and then conveyed down the line to the next station. At the stations where seat parts are assembled with screws according to a predetermined torque, torque reaction arm drivers are used. Torque reaction arm drivers provide an indication of the amount of torque applied during a fastening operation.

To achieve high volume assembly and to keep conveyor lines short, typically several different screws are fastened by a single worker at a given assembly station along the line. For example, a common arrangement is a seat assembly station where several screws are installed into the seat requiring a predetermined applied torque of the same value. This system includes a mechanism that keeps a seat at a station until the desired number of torque values is achieved with the torque reaction arm that is equal to the number of screws being installed.

While the torque reaction arm is capable of providing an indication of driven torque, this type of system can be easily tricked or subject to failure. In particular, if the worker of the torque reaction arm drives the same screw twice he can accidentally provide two torque values for one screw. In repetitive work operations requiring several tasks at a single assembly station, workers can forget which screw has been properly fastened or otherwise make an accidental error in fastening the same screw twice. The result is that one or more screws have been improperly fastened despite the total number of torque values has been achieved for the station (thereby allowing release of the seat from the station for further downstream assembly).

Even without mistakes, some workers have been known to intentionally bypass or trick existing systems. In particular, there have been instances where a worker drives a screw, then reverses the same screw and then refastens that same screw at the same location to get more than one good output value at the same location to in effect trick the system. Workers have even been known to drive a screw mounted in a panel proximate the assembly station to intentionally bypass or trick the system. The cause of these problems is difficult to understand but it may include worker frustration or fatigue with respect to properly fastening screws into a seat.

One approach to reducing employee mistakes in fastening operations is to reduce the number of tasks performed at a given work station. However, this approach increases the length and cost of the assembly line and decreases worker efficiency. Another approach is to install quality control in the form of close supervision or downstream torque checking to ensure quality and accuracy of fastening operations. However, increased supervision also increases costs and decreases overall efficiency of an assembly line. There have even been instances where companies have discovered such fastening problems of a large scale level and have had to conduct massive quality control operations by manually checking the proper installation of fasteners and thousands of torque values on seats that have already been run through the line because the torque values have not been stored. This is both time consuming and costly.

### BRIEF SUMMARY OF THE INVENTION

In light of the above, it is a general aim of the present invention to provide a more reliable and more fool-proof way to conduct fastening operations in assembling an article of assembly.

In that regard, it is also a further object of the present invention to provide a more efficient way of ensuring fastening operations are performed correctly on an article of assembly and storing the torque values with a unique identification number.

In accordance with these and other objectives, the present invention is directed towards a more reliable method for assembling an article of assembly in which the article of assembly having multiple fastening locations in spaced apart relation and storing the torque values with a unique identification number. The method comprises holding the article of assembly in a fixed position while providing at least two different types of targets fixed relative to the article of assembly that correspond to the individual fastening locations. Fasteners are fastened into the article of assembly at the various fastening locations. When fastening is occurring at one of the fastening locations, one of the targets is being sensed. Based on the target sensed, an electronic target output is generated that differentiates between the different types of targets thereby indicating fastening location of the fastening tool. The electronic target output can be used for electronic control or alarm purposes. The method further comprises an interface for setting the unique identification number so that the actual numeric results of the run down for a particular fastener can be traced to the position and assembly the fastener is associated with.

Further aspects of the present invention relate to implementations on conveyor systems including both continuous and non-continuous or intermittent type conveyor systems.

Other aspects, objectives and advantages of the invention will become more apparent from the following detailed description when taken in conjunction with the accompanying drawings.

### BRIEF DESCRIPTION OF THE DRAWINGS

FIG. 1 is an isometric and partly schematic view of a seat assembly station where the present invention may be used.

FIG. 2 is a side elevation view of the seat assembly station illustrated in FIG. 1.

FIG. 3 is front elevation view of the seat assembly station illustrated in FIG. 1.

FIG. 4 is a block diagram view of an embodiment on which the present invention may reside;

FIG. 5 is a block diagram view of an embodiment of the invention in a single station environment;

FIG. 6 is a block diagram view of an embodiment of the invention in a multi-station environment;

FIG. 7 is a flow chart illustrating the steps taken to associate a unique identifier to a torque value in the single station environment of FIG. 5; and

FIG. 8 is a flow chart illustrating the steps taken to associate a unique identifier to a torque value in the multi-station environment of FIG. 6.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The invention provides a method to automatically provide a unique identifier to torque values of fasteners in an assembly. Previously, the torque results were stored in a database without having identifiable information, requiring a user to manually check the proper installation of fasteners and torque values on items that have been run through the assembly. As a result of the invention, users do not need to manually check the proper installation of fasteners and thousands of torque values on seats that have already been run through the line.

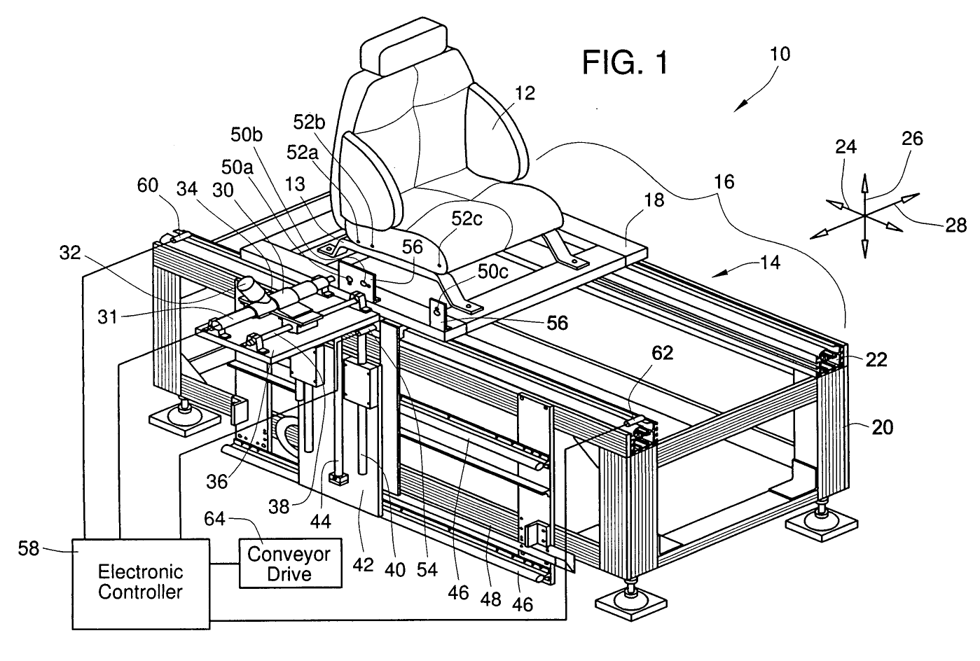

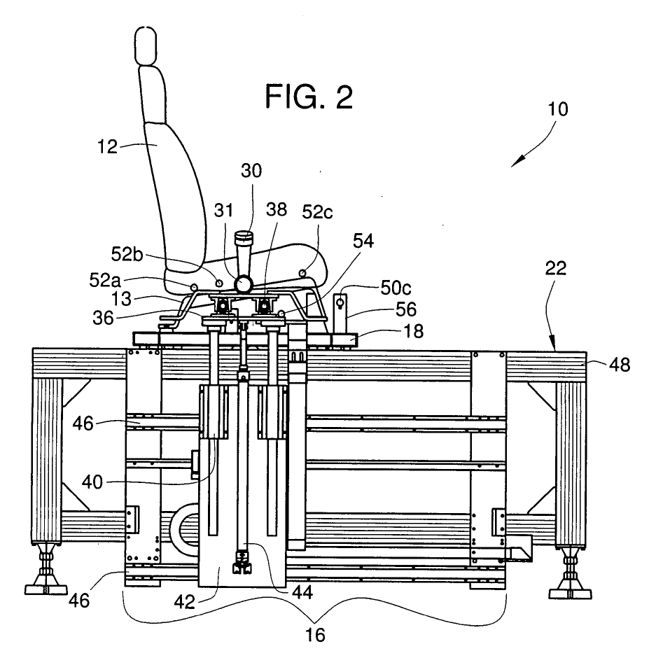

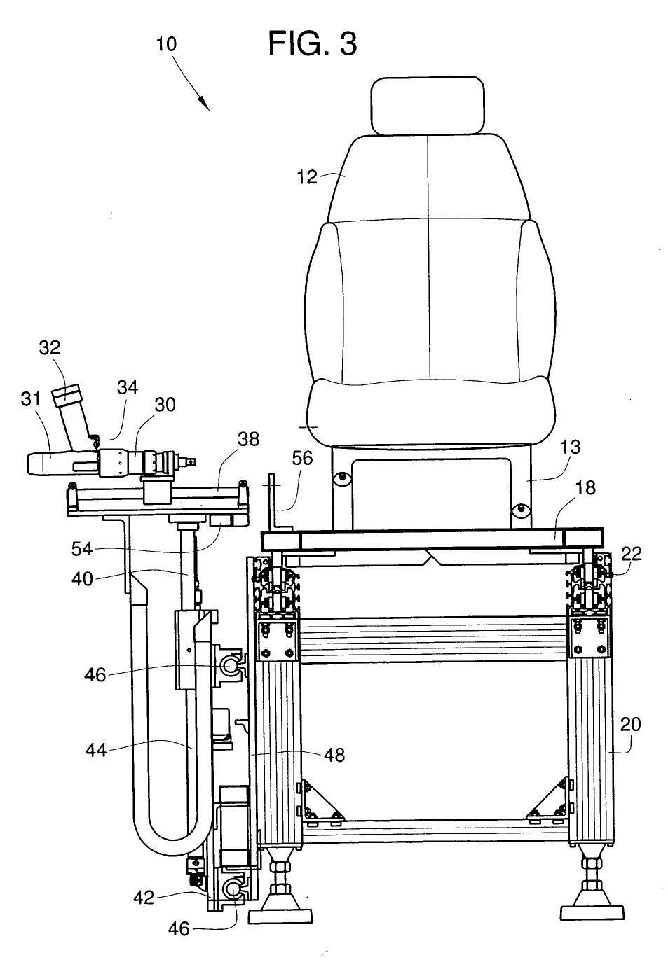

Turning to the drawings, wherein like reference numerals refer to like elements, for purposes of illustration, a preferred embodiment of the operating environment of the present invention has been illustrated in FIGS. 1-4 as embodied in an assembly station 10 for assembling articles of assembly illustrated in the form of automotive seats 12. Although only one assembly station 10 is fully illustrated in FIGS. 1-3, it will be appreciated that the assembly station 10 is one of several assembly stations that are typically disposed in a predetermined sequence whereby assembly work operations are performed.

To transport the seats 12 through the various stations, a conveyor 14 is provided that runs through the assembly station 10. The conveyor 14 is illustrated as a continuous type in which the conveyor 14 runs and moves the seats 12 substantially continuously. In particular, the conveyor 14 will typically run on a continuous basis and continuously move the seats 12 downstream through the various stations unless the necessary work operations any of the particular stations are not performed within the allotted time given for that station, or a breakdown occurs, or other similar event occurs requiring stoppage of the conveyor 14. As can be seen in FIG. 1, the assembly station 10 has a span 16 of work area over which the work operations can be performed at the illustrated assembly station 10. The amount of time a seat 14 typically spends at an assembly station is equal to the length of the span 16 divided by the operating speed of the conveyor 14.

The conveyor 14 includes a stationary support frame 20 and a moving line 22. A plurality of seat fixtures 18 are affixed to the moving line 22 at equidistant intervals. The seat fixtures 18 clamp onto or other wise hold the seats 12 in a fixed position for assembly operations. Unassembled base frames of seats 12 are clamped into the fixtures 18 (typically through locating pins and a clamping mechanism that are not shown) at the upstream input location of the conveyor 14, while assembly seats are removed from the fixtures 18 at the downstream output location of the conveyor 14. The fixtures 18 are recycled and used over and over again for assembling seats 12.

For purposes of reference, three mutually perpendicular axes 24, 26, 28 have been shown. The axes include a horizontal axis 24 parallel to the conveyor 14, a vertical axis 26 and a tool plunging axis 28.

At the illustrated assembly station 10, a fastening tool is provided in the illustrated form of an electrically powered, torque reaction arm, screw driver 30 (“power screw driver”) for driving threaded bolts, screws or other threaded fasteners into the frame 13 of the seat 12. The power screw driver 30 is manually operated including a handle 32 and a trigger 34 that provides for forward and reverse modes to correspondingly drive or remove threaded fasteners. The power screw driver 30 also comprises an integral torque monitor 31 that is capable of providing an output of the torque applied to fasteners by the power screw driver 30.

The power screw driver 30 is mounted on a horizontal tool platform 36 via a first linear rail mechanism 38 that extends the tool plunging axis 28. The first linear rail mechanism 38 allows for sliding linear movement of the driver 30 in the plunging axis 28. The horizontal tool platform 36 is in turn supported by a second linear rail mechanism 40 that extends in the vertical axis 26. The second linear rail mechanism 40 is mounted to a vertical support plate 42. The second linear rail mechanism 40 allows for sliding linear movement of the driver 30 in the vertical axis 26. A supporting recoil cylinder 44 may be used to support the horizontal platform 36 at the desired height and to counteract the force of gravity for the support assembly of the driver. The vertical support plate 42 is in turn supported by a third linear rail mechanism 46 that is mounted to an adjacent wall or side 48 of the conveyor 14. The third linear rail mechanism 46 allows for sliding linear movement of the driver 30 in the horizontal axis 26 parallel to the length of the conveyor 14 at the assembly station 10. The length of the third linear rail mechanism 46 also determines and sets the span 16 of the assembly station 10 over which fastening operations can be performed with the power screw driver 30. From the foregoing, it can be seen that the power screw driver 30 can be manipulated along the three different axes 24, 26, 28, relative to the conveyor 14 and or fixtures 18 to fasten screws into seats 12 as desired.

The system described in U.S. Pat. No. 6,763,573, hereby incorporated by reference in its entirety, can be used to verify that fastening operations are performed correctly on an article of assembly and to obtain an indication of the driven torque applied at a fastening location. It is noted that other systems may be used with the invention.

To aid in understanding the invention, the system of U.S. Pat. No. 6,763,573 shall be briefly described. Further details are described in U.S. Pat. No. 6,763,573. The embodiment includes a plurality of differentiated targets 50a, 50b, 50c corresponding to different fastening locations 52a, 52b, 52c on the seat 12, respectively, and a target sensor in the form of a machine vision camera 54 for sensing the targets 50a-c. The camera 54 is fixed relative to the power screw driver 30 in at least one axis, up to all three axes. For example the target sensor camera 54 may be mounted to the horizontal platform 36 and is therefore fixed relative to the power screw driver 30 in the vertical and horizontal axes 24, 26.

The individual targets 50a-c are fixed relative to the seat 12 in spaced apart relation to their respective fastening locations 52a-c on the seat 12. The spaced apart relation is substantially the same between each of the targets 50a-c and corresponding fastening locations 52a-c in terms of distance (horizontal and vertical) and angular orientation. This equidistant spacing is also substantially the same as that between the tip end of the power screw driver 30 and the machine vision camera 54. In this manner, and with the camera 54 aligned parallel to the tool plunging axis 28, the machine vision camera 54 will sense the first target 50a when the power screw driver 30 is at the first fastening location 52a, will sense the second target 50b when the power screw driver 30 is at the second fastening location 52b, and will sense the third target 50c when the power screw driver 30 is at the third fastening location 52c.

To fix the targets 50a-c relative to the fixture 18, the targets 50a-c are preferably provided on panels 56 that in turn are mounted to the each one of the fixtures 18. The targets 50a-c may also be mounted to the moving line 22 of the conveyor (since the conveyor moves at the same speed as the seats) or mounted to or integrally provided by the seats 18 themselves to provide for fixed targets relative to the seats. For intermittent stop and go systems, the targets may be fixed stationary at the assembly station such as to the stationary support frame of the conveyor because the seat is stopped in position while work operations are being performed.

As shown in FIG. 1, each of the targets 50a-c has a distinctive characteristic that is different than that of the other targets 50a-c, which allows for differentiation of the targets 50a-50c. In FIG. 1 the distinctiveness is provided through different angular orientations of a large bolt head target and a small bolt head target. The machine vision camera 54 generates an electronic output that differentiates between the different targets 50a-50c. This electronic output of the machine vision camera 54 is communicated to a processor or electronic controller 58. The electronic controller 58 may be a single unit or may consist of separate modules where each module performs one or more functions.

The electronic controller 58 has several outputs and inputs and can utilize the electronic output from the machine vision camera 54 for a variety of purposes such as sounding an alarm, stopping the conveyor 14 and/or collecting data for analysis or quality control purposes. The actual purpose may vary between applications.

In continuous conveyor seat assembly systems where certain screw torques or fastening sequences may be critical, the electronic output from the machine vision camera 54 may be used to stop the conveyor 14 in the event that not all fastening operations are performed correctly as required, to allow further time to finish those operations at the illustrated assembly station 10. Although this can stop the entire moving line and affect other upstream or downstream stations, the disclosed embodiment ensures fool-proof assembly that ensures that proper fastening torques at each of the fastening locations 52a-c and/or fastening sequences at the fastening locations 52a-c is achieved with no further quality control required over fastening operations. In typical assembly line set ups, the conveyor line 22 will be moving at a speed that is typically sufficient to allow all work to be accomplished in the allotted time at each of the assembly stations along the conveyor.

At the illustrated assembly station 10 of FIG. 1, the electronic controller 58 has an position sensor input indicating when seats 12 enter and are about to leave the assembly station 10. This input may include a first proximity sensor 60 located near the entrance to the assembly station 10 for indicating when a seat is about to enter the station 10 and includes a second proximity sensor 62 located near the exit of the assembly station 10 for indicating when a seat is about to leave the station 10. The electronic controller 58 also has a connection to the conveyor drive 64 that is operable to stop the moving line 22 of the conveyor 14. The electronic controller 58 also has a connection to the torque reaction arm or driver 30 for activating the driver 30 when the driver 30 is in a proper fastening position and disabling the driver 30 when the driver 30 is not in a proper position to fasten at one of the fastening locations 52a-c. The electronic controller 58 also receives feedback from a torque monitor 31 integral with the driver 30 to provide an indication of the driven torque applied at a fastening location.

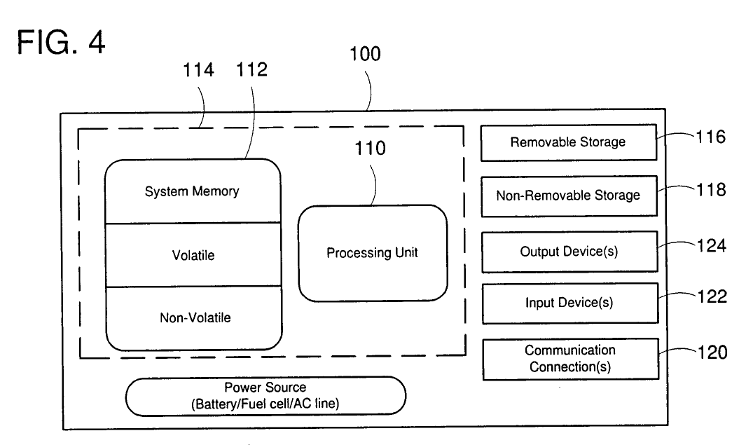

Prior to describing the invention in detail, an exemplary controller in which the invention may be implemented is first described with reference to FIG. 4. Although not required, the invention will be described in the general context of computer-executable instructions, such as program modules, being executed by a computing device such as an actuator controller. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 4 shows an exemplary computing device 100 (e.g., controller 58) for implementing the invention. One or more computing devices 100 may be used to implement the invention. In its most basic configuration, the computing device 100 includes at least a processing unit 110 and a memory 1112. Depending on the exact configuration and type of computing device, the memory 112 may be volatile (such as RAM), non-volatile (such as ROM, flash memory, etc.) or some combination of the two. This most basic configuration is illustrated in FIG. 4 by a dashed line 114. Additionally, the device 100 may also have additional features/functionality. For example, the device 100 may also include additional storage (removable and/or non-removable) including, but not limited to, magnetic or optical disks or tapes. Such additional storage is illustrated in FIG. 4 by a removable storage 116 and a non-removable storage 118. Computer storage media includes volatile and nonvolatile, removable and non-removable media implemented in any method or technology for storage of information such as computer readable instructions, data structures, program modules or other data. The memory 112, the removable storage 116 and the non-removable storage 118 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by the device 100. Any such computer storage media may be part of the device 100.

The device 100 may also contain one or more communications connections 120 that allow the device to communicate with other devices. The communications connections 120 are an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. As discussed above, the term computer readable media as used herein includes both storage media and communication media.

The device 100 may also have one or more input devices 122 such as keyboard, mouse, pen, voice input device, touch-input device, etc. One or more output devices 124 such as a display, speakers, printer, etc. may also be included. All these devices are well known in the art and need not be discussed at greater length here.

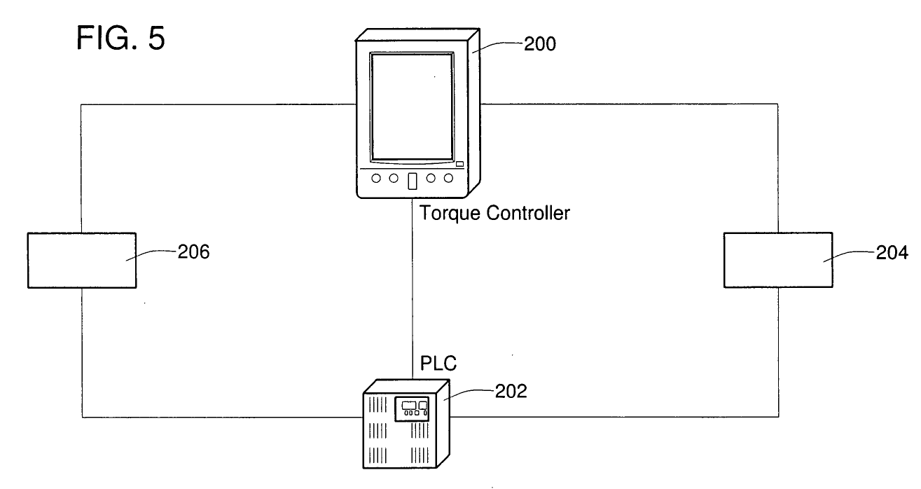

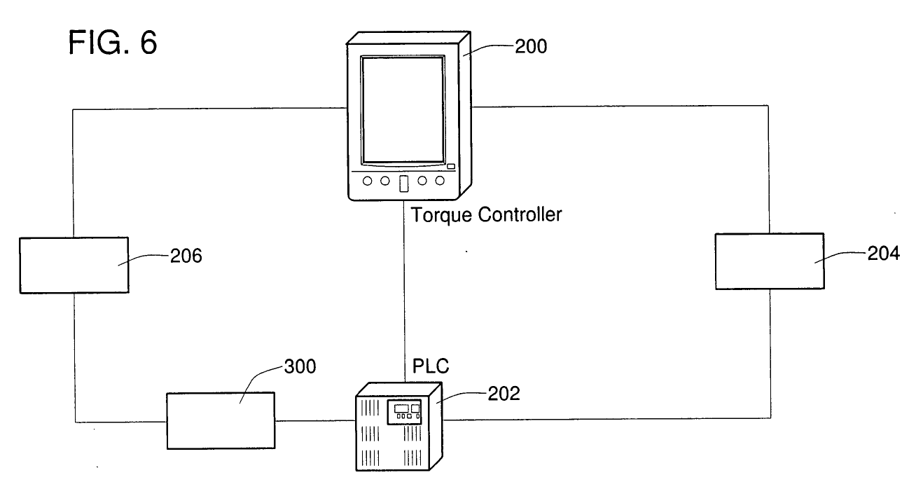

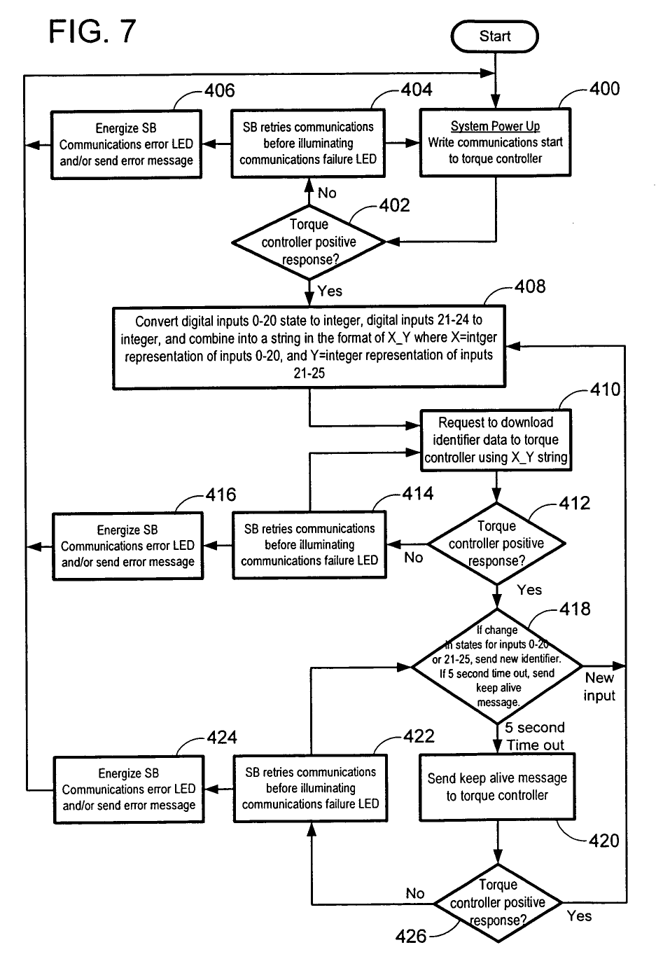

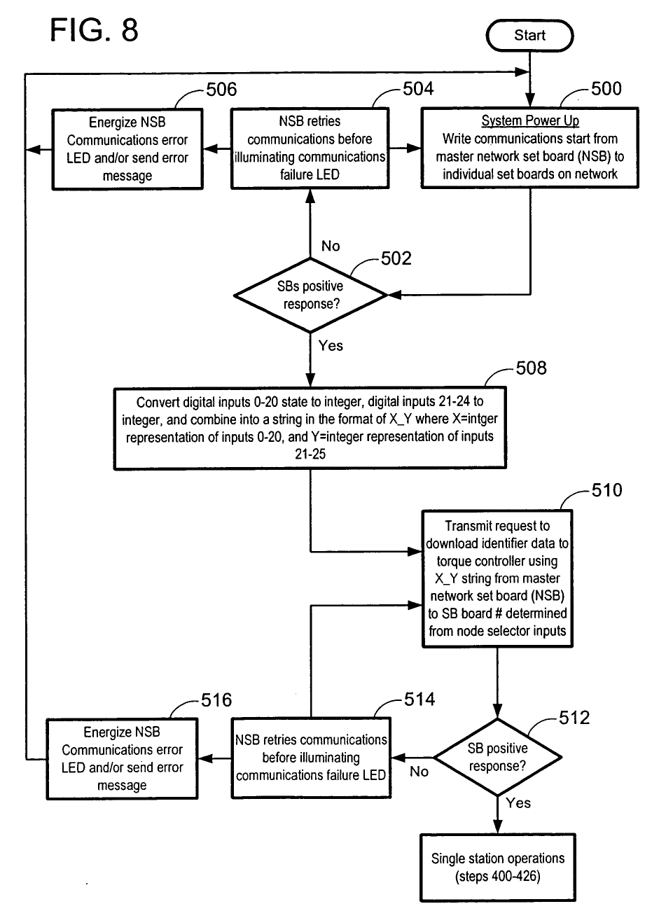

Turning now to FIGS. 5 and 6 in conjunction with FIGS. 7 and 8, the steps taken of the invention shall now be described. FIG. 5 shows a simplified block diagram of the invention in a single station environment and FIG. 6 shows a simplified block diagram of the invention in a multiple station environment.

For a single station environment, the torque controller 200 and programmable logic controller (PLC) 202 control the torque arm 204 (e.g., power screw driver 30) as described above. The torque controller 200 is used to control and collect the torque value for running down assembly fasteners. The torque controller 200 also reports the run down value for the fastener and works in conjunction with traceability software for storing the numeric values associated with the run down in reference to a unique identification number.

The PLC 202 is used, among other things, as a sequencing controller to generate digital outputs that are input to the set board 206 for calculating and setting the unique identification number in the torque controller 200. The PLC 202 is responsible for incrementing portions of the digital outputs for the creation of a unique identifier for each assembly fastener. The PCL 202 interfaces to the torque controller 200 to collect the torque status for determining when to increment the digital outputs and to enable the torque controller 200 when the system is ready to monitor another run down.

The torque arm 204 verifies the position and torque OK status for each bolt in an assembly. The torque arm 204 can force a predetermined run down order by checking and verifying the run down position before allowing the torque tool to be activated.

The set board 206 converts the digital inputs (i.e., the digital outputs of the PCL 202) into a string. In one embodiment, the digital inputs consist of two sets of data. For example, one set is a set of twenty one inputs and the other set is a set of four inputs. The two sets can be used, for example, to identify the assembly with the first set and identify the fastener position with the second set. The set board 206 converts the digital inputs into a string with the format X_Y, where X is the integer representation of the first set of inputs and Y is the integer representation of the second set of inputs. The string is transmitted to the torque controller 200 for the torque controller 200 to use to identify the fastener being run down by the torque controller 200 and torque arm 204. The string is transmitted using the torque controller's protocol using Ethernet or serial communications and the like.

In a multiple station environment, each PLC 202 communicates with a network set board 300 with an additional data set that identifies which set board 206 the PCL 202 is using. The network set board 300 performs the conversion and transmits it to the set board 206 based on the integer value of the additional data set sent by the PLC 202.

Turning now to FIG. 7, the steps the set board 206 takes is illustrated. During system power up, the set board 206 writes a communications start to the torque controller (step 400). If the torque controller 200 does not send a response (step 402), the set board 206 retries communications a predetermined number of times (e.g., three times) (step 404) before indicating a failure has occurred (step 406). The failure indication may be in the form of energizing an LED, signaling an alarm, sending an error message, etc.

If the torque controller 200 produces a positive response, the digital input sets are converted to integer numbers as previously described. A request is sent to the torque controller 200 to download the unique identifier using the X_Y string (step 410). If the torque controller 200 does not send a response to the request (step 412), the set board 206 retries communications a predetermined number of times (step 414) before indicating a failure has occurred (step 416).

If changes in the data inputs occur, steps 408-416 are repeated. If no changes occur within a five second time period (step 418), a five second time out occurs and a keep alive message is sent to the controller (step 420). The keep alive message can be used to determine if the torque controller 200 is responsive.

If the torque controller 200 does not send a response to the keep alive message, the set board 206 retries communications a predetermined number of times (step 422) before indicating a failure has occurred (step 424). If the torque controller 200 produces a positive response, steps 418 to 424 are repeated until a change occurs and then steps 408-426 are repeated.

The torque controller 200 receives the unique identifier and uses it to identify the torque value of the run down of the fastener and stores it with the run down data for each fastener.

In a multiple station environment during system power up, the network set board 300 writes a communications start to individual set boards 206 (step 500). If an individual set board 206 does not send a response (step 502), the network set board 300 retries communications a predetermined number of times (step 504) before indicating a failure has occurred (step 506). The failure indication may be in the form of energizing an LED, signaling an alarm, sending an error message, etc.

If the individual set board 206 produces a positive response, the digital input sets received from a PLC 202 for the individual set board 206 are converted to integer numbers as previously described. A request is sent to the individual set board 206 identified by the third data set to download the unique identifier using the X_Y string (step 510). If the individual set board 206 does not send a response to the request (step 512), the network set board 300 retries communications a predetermined number of times (step 514) before indicating a failure has occurred (step 516).

If the individual set board 206 produces a positive response to the request, the network set board 300 waits for additional inputs from PLCs and repeats steps 508 to 512 when another set of inputs are received. The individual set board 206 proceeds with steps 400 to 426. Step 408 is not performed if the string received from the network board set 300 is in the same protocol that is used to communicate with the torque controller 200. Step 408 is performed to change the protocol if the protocol needs changing.

From the foregoing, it can be seen that a full proof method to relate torque values to a fastener position has been presented. A unique number based on a position location is used in conjunction with running fasteners in a fixed order allows a person to be able to prove the torque value of an installed fastener using the teachings of the present invention. When the torque controller stores the information in a database, a user can query the database by assembly serial number and fastener number.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “computer-implemented” is to be construed to cover hand-held devices, single or multi-processor systems, microprocessor based or programmable consumer or industrial electronics, network PCs, laptops, minicomputers, mainframe computers, programmable arrays, actuator controllers, any combinations of the above, and similar systems and devices. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method to set an unique identifier for fasteners in an assembly system having a torque controller that controls and collects the torque value for running down assembly fasteners, the method comprising the steps of:
a) receiving an input having indications of an identification number and a fastener number for an assembly fastener, the identification number and fastener number forming the unique identifier;
b) converting the input into a string having a pre-determined format readable by the torque controller;
c) sending the string to the torque controller; and
d) repeating steps a-c for each input received.

2. The method of claim 1 wherein the pre-determined format is in the format of X_Y, where X and Y are integer values.

3. The method of claim 2 wherein the input comprises two sets of data and X is the integer value of one of the sets of data and Y is the integer value of the other of the sets of data.

4. The method of claim 1 wherein the step of repeating steps a-c for each input received includes the step of repeating steps a-c if a change in state of the input occurs.

5. The method of claim 1 further comprising the steps of:
associating the string with the torque value of a fastener; and
storing the string with the torque value.

6. The method of claim 1 wherein the step of receiving the input comprises receiving a first set of inputs and a second set of inputs, the first set of inputs identifying the identification number and the second set of inputs identifying a fastener number.

7. The method of claim 6 wherein the identification number comprises one of a serial number and a sequence number.

8. The method of claim 1 wherein the torque controller comprises a plurality of torque controllers and the input comprises three sets of data, one of the sets of data indicating and the other sets of data provide the indication of the identification number and the fastener number.

9. A computer-readable medium having computer executable instructions for setting an unique identifier for fasteners in an assembly system having a torque controller that controls and collects the torque value for running down assembly fasteners, the computer executable instructions performing the steps of:
a) receiving an input having indications of an identification number and a fastener number for an assembly fastener, the identification number and fastener number forming the unique identifier;
b) converting the input into a string having a pre-determined format readable by the torque controller;
c) sending the string to the torque controller; and
d) repeating steps a-c for each input received.

10. The computer-readable medium of claim 9 wherein the pre-determined format is in the format of X_Y, where X and Y are integer values.

11. The computer-readable medium of claim 10 wherein the input comprises two sets of data and X is the integer value of one of the sets of data and Y is the integer value of the other of the sets of data.

12. The computer-readable medium of claim 9 wherein the step of repeating steps a-c for each input received includes the step of repeating steps a-c if a change in state of the input occurs.

13. The computer-readable medium of claim 9 having further computer-executable instructions for performing the steps comprising:
associating the string with the torque value of a fastener; and
storing the string with the torque value.

14. The computer-readable medium of claim 9 wherein the step of receiving the input comprises receiving a first set of inputs and a second set of inputs, the first set of inputs identifying the identification number and the second set of inputs identifying a fastener number.

15. The computer-readable medium of claim 14 wherein the identification number comprises one of a serial number and a sequence number.

16. The computer-readable medium of claim 9 wherein the torque controller comprises a plurality of torque controllers and the input comprises three sets of data, one of the sets of data indicating and the other sets of data provide the indication of the identification number and the fastener number.
